(19) United States
(12) Patent Application Publication
(10) Pub. No.: US 2026/0281610 A1
(43) Pub. Date: Sep. 17, 2026

(54) VEHICLE LOUDSPEAKER AND SOUND SYSTEM

(71) Applicant: SUZHOU SONAVOX ELECTRONICS CO., LTD., Suzhou, Jiangsu (CN)

(72) Inventors: Peng Gao, Suzhou, Jiangsu (CN); Zhanqing Dong, Suzhou, Jiangsu (CN); Hanyu Gu, Suzhou, Jiangsu (CN); Minhua He, Suzhou, Jiangsu (CN); Zhenyu Tang, Suzhou, Jiangsu (CN); Xiaofeng Ding, Suzhou, Jiangsu (CN)

(21) Appl. No.: 18/872,226

(22) PCT Filed: Nov. 18, 2022
(86) PCT No.: PCT/CN2022/132909

§ 371 Date: Dec. 5, 2024

(30) Foreign Application Priority Data
Sep. 9, 2022 (CN) 202211102665.4

(51) Int. Cl. H04R 1/28; B60N 2/879; H04R 1/02; H04R 7/12; H04R 7/16; H04R 9/02; H04R 9/04

(52) U.S. Cl. CPC H04R 1/288; B60N 2/879; H04R 1/023; H04R 7/12; H04R 7/16; H04R 9/025; H04R 9/045; H04R 2499/13

(57) ABSTRACT

Disclosed are a vehicle loudspeaker and sound system. The vehicle loudspeaker includes a frame, a diaphragm having an outer edge connected to the frame, a voice coil with an upper end portion connected to a middle portion of the diaphragm, and a magnetic drive unit having a magnetic gap, the magnetic drive unit being arranged on the frame, wherein a lower end portion of the voice coil is inserted into the magnetic gap. The vehicle loudspeaker further includes two independent dampers spaced apart from each other, the two dampers are respectively located on two opposite sides of the voice coil, a part of an edge of each damper is connected to the frame, the diaphragm has two first connecting portions recessed downwards, and the first connecting portions are connected to the dampers respectively.

This application claims priority from Chinese Patent Application No. CN 2022111026654 filed on September 9, 2022.

### TECHNICAL FIELD

The present disclosure relates to a vehicle loudspeaker and a vehicle sound system.

### BACKGROUND

Loudspeakers usually comprise a diaphragm, a voice coil, a damper, a magnetic drive unit, etc., but for vehicle loudspeakers used in vehicle sound systems, especially headrest loudspeakers or roof loudspeakers, they need to meet the requirements of light weight, small size, high power, good low-frequency lower limit and so on. However, for conventional loudspeakers with a single damper, they are generally of large mass, large volume and large depth of installation; for loudspeakers with no damper, although they are of lighter weight and smaller volume, they have lower power. These two types of loudspeakers are not suitable for the loudspeakers used in automobile roof or headrest sound systems.

### SUMMARY

Aiming at the above problems, an object of the present disclosure is to provide a vehicle loudspeaker, which can not only have the advantages of light weight and small volume, but also ensure the advantages such as high power and good low-frequency lower limit.

Another object of the present disclosure is to provide a vehicle sound system.

An aspect of the present disclosure provides a vehicle loudspeaker including:
a frame;
a diaphragm having an outer edge connected to the frame;
a voice coil, an upper end portion of the voice coil being connected to a middle portion of the diaphragm; and
a magnetic drive unit having a magnetic gap, the magnetic drive unit being arranged on the frame;
wherein, the magnetic drive unit is arranged on the frame;
the vehicle loudspeaker further includes two independent dampers spaced apart from each other, the two dampers are respectively located on two opposite sides of the voice coil, a part of an edge of each damper is connected to the frame, the diaphragm has two first connecting portions recessed downwards, and the first connecting portions are connected to the dampers respectively.

In some embodiments, the frame comprises a housing and a magnetic drive unit mounting base, the housing is hollow and has an upper end that is open, the outer edge of the diaphragm is connected to an upper surface of the housing, the housing has a pair of long edges opposite to each other, the magnetic drive unit mounting base is located in the housing and fixedly connected to middle portions of the long edges, the magnetic drive unit is arranged on the magnetic drive unit mounting base, the dampers are respectively arranged on two opposite sides of the magnetic drive unit mounting base, and the dampers are located between the magnetic drive unit and the housing.

In some embodiments, the frame further comprises two damper mounting pieces, the dampers are arranged on the damper mounting pieces respectively; the housing further has two short edges connected between end portions of the two long edges, and the damper mounting pieces are fixedly connected to the end portions of the long edges and/or the short edges.

In some embodiments, each of the dampers comprises an outer edge connected to one of the damper mounting pieces and a second connecting portion connected to the one of the first connecting portions of the diaphragm, and the outer edge is lower than the second connecting portion.

In some embodiments, each of the dampers further comprises a corrugated portion between the outer edge and the second connecting portion, and the outer edge is lower than the corrugated portion.

In some embodiments, the outer edge is in a shape of an arc or a part of a rounded rectangle.

In some embodiments, an orthogonal projection of the housing on the horizontal plane is a rectangle or a rounded rectangle, and the voice coil, the magnetic drive unit and the dampers are all accommodated in the housing.

In some embodiments, the diaphragm has a diaphragm center hole, the voice coil passes through the diaphragm center hole, and a dust cover is arranged on an upper end of the voice coil; an orthogonal projection of the diaphragm on the horizontal plane is an oval or racetrack shape with a hole in a middle portion, and the diaphragm gradually tilts downwards from its edge to the diaphragm center hole.

Herein, the term “racetrack shape” specifically refers to a shape formed by combining a rectangle and two semicircles/arches, where the rectangle is located between the two semicircles/arches. In some embodiments, the diaphragm has a plurality of reinforcing portions arched upwards or recessed downwards, and the plurality of reinforcing portions is respectively located at two opposite sides of the diaphragm center hole and symmetrically arranged.

In some embodiments, the reinforcing portions extend along directions from the diaphragm center hole to the short edges of the frame.

In some embodiments, the magnetic drive unit is single, and the circuit system comprises a T-yoke, and a magnetic steel and front panel sleeved on the T-yoke, and the front panel is fixedly connected to the frame.

In some embodiments, the middle portion of a lower surface of the T-yoke is recessed upwards to form a first blind hole; the middle portion of an upper surface of a column portion of the T-yoke is recessed downwards to form a second blind hole.

In some embodiments, an upper surface of a base of the T-yoke is further provided with a circle of groove surrounding its column portion.

A second aspect of the present disclosure provides a vehicle sound system comprising a headrest loudspeaker, the headrest loudspeaker comprises the vehicle loudspeaker mentioned above. Specifically, the headrest loudspeaker is a loudspeaker that is mounted in a headrest of a vehicle seat.

A third aspect of the present disclosure provides a vehicle sound system comprising a roof loudspeaker, the roof loudspeaker comprises the vehicle loudspeaker mentioned above. Specifically, the roof loudspeaker is a loudspeaker that is mounted on the roof of a vehicle.

The present disclosure adopts the above solutions, and has the following advantages over conventional art:
the vehicle loudspeaker of the present disclosure reduces the overall height of the loudspeaker, increases the vibration amplitude of the loudspeaker, effectively reduces the resonant frequency of the loudspeaker so as to improve the low-frequency deepness, solves the problem of traditional loudspeaker structures of low bass extension caused by the reduction of damper area, and the problems of low power, transient distortion, and lateral movement distortion of the voice coil when there is no damper, and realizes the miniaturization and high-power function of the loudspeaker, at the same time, it can be mounted in narrow spaces, saving space inside vehicle and increasing the low-frequency volume of the loudspeaker. In short, it can not only have the advantages of light weight and small volume, but also ensure the advantages such as high power and good lower limit of low-frequency.

### BRIEF DESCRIPTION OF THE DRAWINGS

For more clearly explaining the technical solutions in the embodiments of the present disclosure, the accompanying drawings used to describe the embodiments are simply introduced in the following. Apparently, the below described drawings merely show a part of the embodiments of the present disclosure, and those skilled in the art can obtain other drawings according to the accompanying drawings without creative work.

FIG. 1 is an exploded schematic diagram of a vehicle loudspeaker according to Embodiment 1 of the present disclosure.

FIG. 2 is a cross sectional view of the vehicle loudspeaker according to Embodiment 1 of the present disclosure.

FIG. 3 is a stereogram of a vehicle loudspeaker according to Embodiment 2 of the present disclosure.

FIG. 4 is an exploded schematic diagram of the vehicle loudspeaker according to Embodiment 2 of the present disclosure.

FIG. 5 is a top view of the vehicle loudspeaker according to Embodiment 2 of the present disclosure.

FIG. 6 is a stereogram of a diaphragm according to Embodiment 2 of the present disclosure.

FIG. 7 is a cross sectional view of the diaphragm shown in FIG. 6 along a direction perpendicular to the short edges.

FIG. 8 is a stereogram of a diaphragm according to Embodiment 3 of the present disclosure.

FIG. 9 is a stereogram of a diaphragm of a comparative example.

FIG. 10 is a comparison chart of distortion curves of loudspeakers of Embodiment 2, Embodiment 3, and the comparative example.

The reference numbers are as follows:
1—frame; 11—housing; 111—long edge; 112—short edge; 12—magnetic drive unit mounting base; 13—damper mounting piece;
2—diaphragm; 20—yoke ring; 21—first connecting portion; 22—diaphragm center hole; 23—reinforcing portion;
3—voice coil; 30—dust cover; 31—lead; 32—soldering lug;
4—magnetic drive unit; 40—magnetic gap; 41—T—yoke; 42—magnetic steel; 43—front panel;
5—damper; 51—outer edge; 52—corrugated portion; 53—second connecting portion.

### DETAILED DESCRIPTION OF EXEMPLARY EMBODIMENTS

In the following, the preferable embodiments of the present disclosure are explained in detail combining with the accompanying drawings so that the advantages and features of the present disclosure can be easily understood by the skilled persons in the art. It should be noted that the explanation on these implementations is to help understanding of the present disclosure, and is not intended to limit the present disclosure. Further, the technical features involved in the various embodiments of the present disclosure described below may be combined with each other if they do not conflict with each other.

In the present disclosure, “inner” and “outer” are defined with reference to the centerline of the voice coil, with the orientation closer to the centerline of the voice coil as inner, and the opposite as outer. The location words “upper”, “lower” and “horizontal” are intended to facilitate understanding of the structure of vehicle loudspeakers by those skilled in the art, and are not to limit the state of loudspeakers installed on the automobiles; for example, loudspeakers can be installed on inclined or upright components inside vehicles, or on lower surfaces of internal components of vehicles.

### Embodiment 1

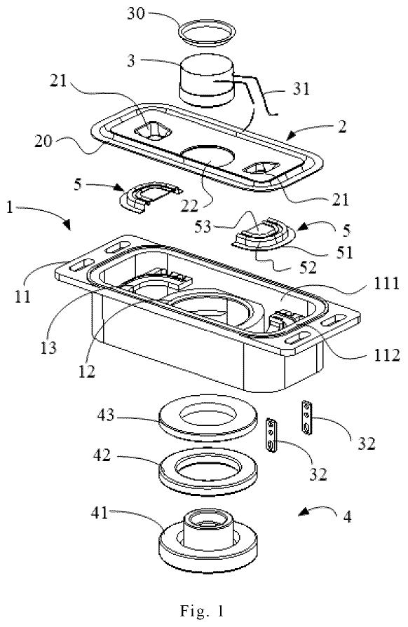

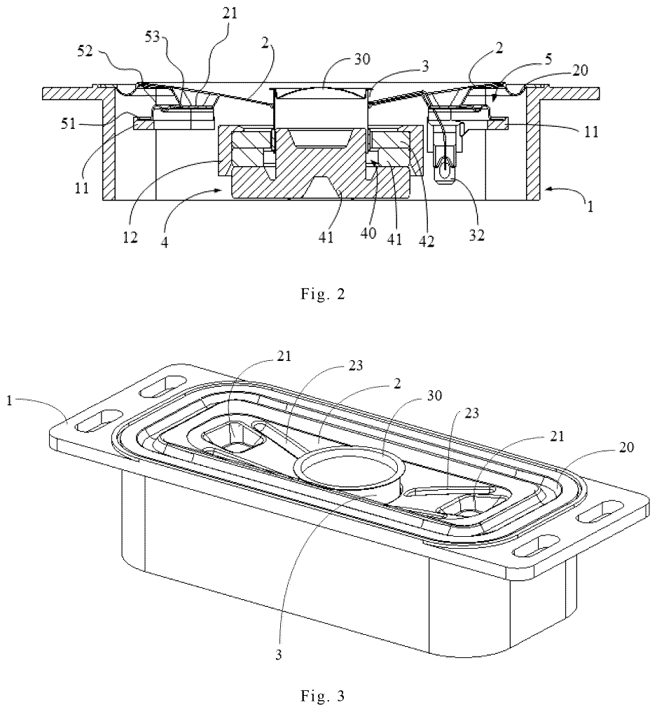

This embodiment provides a vehicle loudspeaker for using in a vehicle sound system. Further, the vehicle loudspeaker is a headrest loudspeaker mounted in a headrest of a vehicle seat and/or a roof loudspeaker mounted on the roof of the vehicle. Referring to FIG. 1 and FIG. 2, the vehicle loudspeaker comprises a frame 1, a diaphragm 2, a voice coil 3, and a magnetic drive unit 4 having a magnetic gap 40. An outer edge of the diaphragm 2 is connected to the frame 1; an upper end portion of the voice coil 3 is connected to a middle portion of the diaphragm 2, and a lower end portion of the voice coil 3 is inserted into the magnetic gap 40; the magnetic drive unit 4 is arranged on the frame 1. The vehicle loudspeaker further comprises two independent dampers 5 that are spaced apart from each other, the two dampers 5 are respectively located on two opposite sides of the voice coil 3 (for example, left and right sides shown in FIG. 2), a portion of an edge of each of the dampers 5 is connected to the frame 1, the diaphragm 2 has two first connecting portions 21 recessed downwards, and the first connecting portions 21 are connected to the dampers 5.

The orthogonal projection of the frame 1 on the horizontal plane is a rectangle or a rounded rectangle, thereby giving the entire loudspeaker a narrow and elongated shape, which can be conveniently installed in a vehicle without occupying excessive internal space of the vehicle. Further, the frame 1 comprises a housing 11, the housing 11 is hollow and has an upper end that is open, the voice coil 3, the magnetic drive unit 4 and the dampers 5 are all accommodated in the housing 11, will be basically not exposed out from the housing 11, and are mounted on other components (such as a headrest frame or roof) of the vehicle via the housing 11, and the housing 11 provides support and protection to the diaphragm 2, the voice coil 3, the magnetic drive unit 4 and the dampers 5. The outer edge of the diaphragm 2 is connected to an upper surface of the housing 11; specifically, the diaphragm 2 covers an upper end of the housing 11, the outer edge of the diaphragm 2 is connected to an upper surface of the housing 11 via a yoke ring 20, and the yoke ring 20 has elasticity and is bonded to the upper surface of the housing 11. The housing 11 has a pair of long edges 111 arranged opposite (extending in the left-right direction in FIG. 2) and two short edges 112 connected between the long edges 111 (extending in a direction perpendicular to the paper of FIG. 2), the two long edges 111 and the two short edges 112 are connected to form a space which is rectangular, rounded rectangular or racetrack-shaped in shape. Herein, the “racetrack shape” refers to a shape formed by combining a rectangle and two semicircles, where the rectangle is located between the two semicircles.

The frame 1 further comprises a magnetic drive unit mounting base 12, the magnetic drive unit mounting base 12 is located in the housing 11 and fixedly connected to middle portions of the long edges 111, and there is a gap between the magnetic drive unit mounting base 12 and the short edges 112 of the housing 11, thus providing a mounting space for the dampers 5. The magnetic drive unit 4 is arranged on the magnetic drive unit mounting base 12. Specifically, the whole magnetic drive unit mounting base 12 is hollow cylinder or ring, and the magnetic drive unit 4 is fixed in the magnetic drive unit mounting base 12. The magnetic drive unit mounting base 12 is connected to middle portions of the long edges 111 of the housing 11 via several connecting ribs. The frame 1 further comprises two damper mounting pieces 13. Combining FIG. 2, the two damper mounting pieces 13 are respectively located at the left and right sides of the magnetic drive unit mounting base 12, each of the damper mounting pieces 13 is provided with one damper 5, that is, the dampers 5 are arranged between the left and right opposite sides of the magnetic drive unit mounting base 12 and the housing 11. In particular, viewing from the top, the shape of the damper mounting pieces 13 is generally an arc shape. The damper mounting pieces 13 are fixedly connected to left end portions or right end portions of the short edges 112 and/or the long edges 111 of the housing 11 via several connecting ribs. In this embodiment, the damper mounting pieces 13 are fixedly arranged between the long edges 111 via the connecting ribs, and are not connected to and spaced from the short edges 112. Further, the damper mounting pieces 13, the magnetic drive unit mounting base 12, the connecting portions and the housing 11 are integrally formed, for example, formed by integral plastic injection molding, etc. The two damper mounting pieces 13 are symmetrically arranged with respect to the magnetic drive unit mounting base 12.

The dampers 5 comprise outer edges connected to the damper mounting pieces 13 and second connecting portions 53 connected to the first connecting portions 21 of the diaphragm 2, and a corrugated portion 52 between the outer edges 51 and the second connecting portions 53. The outer edges 51 are horizontally arranged, and lower than the corrugated portion 52 and the second connecting portions 53; the shape of the outer edges is an arc or a part of a rounded rectangle, and the outer edges 51 are bonded to the upper surfaces of the damper mounting pieces 13. The corrugated portion 52 has a plurality of peaks and valleys, and its whole is higher than the outer edge 51. The corrugated portion 52 is arranged around the second connecting portions 53, and cross half to three fourths of the perimetric of the second connecting portions 53. The second connecting portions 53 are horizontally arranged, lower surfaces of the first connection portions 21 of the diaphragm 2 are also horizontally arranged, and the two are bonded together.

The diaphragm 2 is symmetrically arranged left and right, and the two first connecting portions 21 thereof are symmetrically arranged. The middle portion of the diaphragm 2 is provided with a diaphragm center hole 22, the voice coil 3 passes through the diaphragm center hole 22, and a dust cover 30 is arranged on an upper end of the voice coil 3. The orthogonal projection of the diaphragm 2 on the horizontal plane is an oval or racetrack shape with a hole in the middle, and the diaphragm 2 gradually tilts downwards from its edge to the diaphragm center hole 22, namely the main body of the diaphragm 2 is tilt provided, generally like a taper.

The upper end portion of the voice coil 3 passes through the diaphragm center hole 22 and is exposed out above the diaphragm 2, the voice coil 3 is bonded to the wall of the diaphragm center hole 22, and the lower end portion of the voice coil 3 is inserted into the magnetic gap 40 of the magnetic drive unit 4. The upper end portion of the voice coil 3 is electrically connected to a pair of leads 31; the diaphragm 2 is provided with lead through-holes, the frame 1 is fixedly provided with a pair of soldering lugs 32 (specifically embedded in one of the damper mounting pieces 13 of the frame 1), and the leads 31 passes through the lead through-holes and are electrically connected to the soldering lugs 32. This pair of soldering lugs 32 may be used to connect a power amplifier and the like, and used to receive a sound source to be played.

The number of the circuit system 4 is one, and the circuit system 4 comprises a magnetically conductive T-yoke 41, and a magnetic steel 42 and front panel 43 sleeved on the T-yoke 41, and the front panel 43 is stacked on the magnetic steel 42, a lower surface of the front panel 43 is bonded to an upper surface of the magnetic steel 42 via glue; the magnetic steel 42 is stacked on the base of the T-yoke 41, a lower surface of the magnetic steel 42 is bonded to an upper surface of the base of the T-yoke 41 via glue; the front panel 43 and the magnetic steel are specifically sleeved on a column portion of the T-yoke 41, and the column portion extends upwards from the base of the T-yoke 41. The magnetic gap 40 is formed between an outer surface of the T-yoke 41 and inner surfaces of the magnetic steel 42 and the front panel 43. The magnetic steel 42 and the front panel 43 are fixedly connected to the frame 1; specifically, the magnetic steel 42 and the front panel 43 are inserted into the magnetic drive unit mounting base 12 and fixedly connected to the magnetic drive unit mounting base 12, for example by glue bonding. The magnetic steel 42 may be a permanent magnet. The middle portion of the lower surface of the T-yoke 41 is recessed upwards to form a first blind hole; the middle portion of an upper surface of a cylindrical portion of the T-yoke 41 is recessed downwards to form a second blind hole. Moreover, an upper surface of the base of the T-yoke 41 is further provided with a circle of groove surrounding its cylindrical portion. The base of the T-yoke 41 may also be connected to the frame 1, to enhance the connection strength.

The frame 1 is further provided with connecting holes, through which it can be installed on the interior decorative plate in a vehicle.

### Embodiment 2

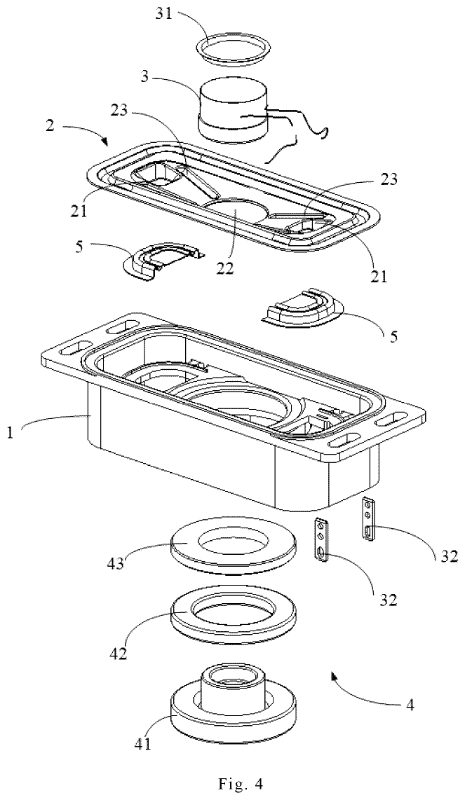

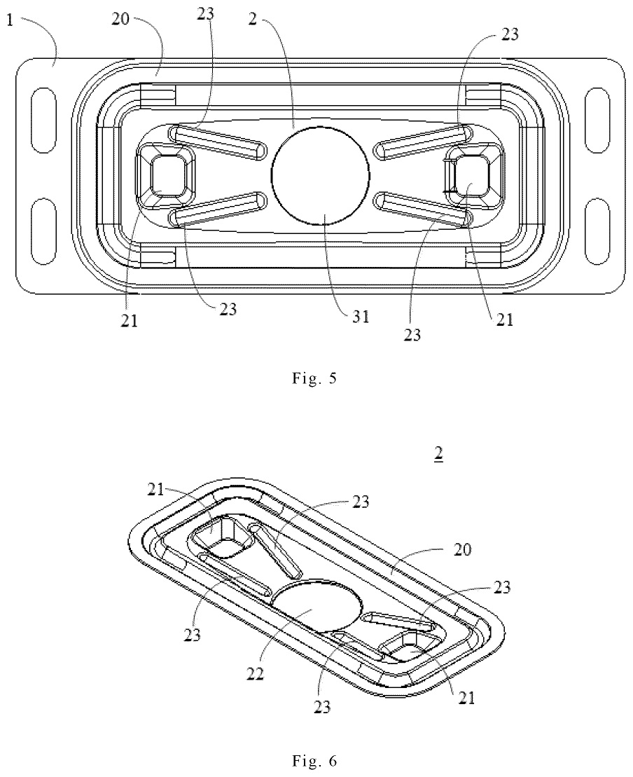

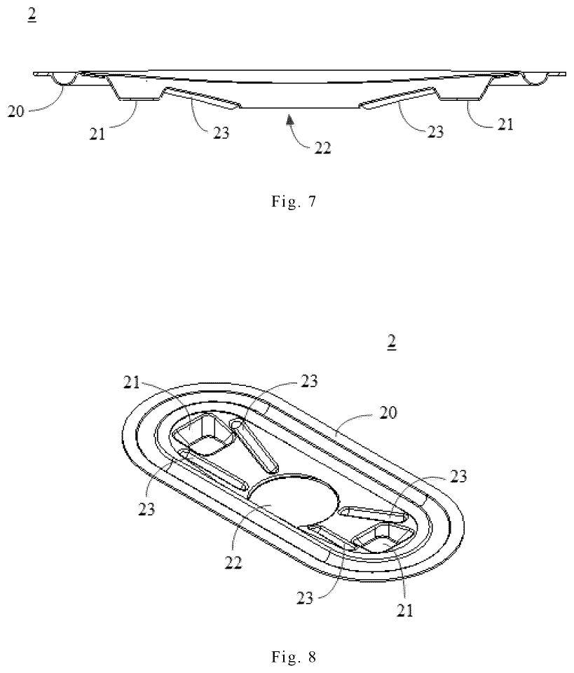

This embodiment differs from Embodiment 1 in the diaphragm 2, and the others are basically the same as Embodiment 1. Referring to FIG. 3 to FIG. 7, the diaphragm 2 further has a plurality of reinforcing portions 23 arched upwards or recessed downwards, and the plurality of reinforcing portions 23 are respectively located at two opposite sides of the diaphragm center hole 22 and symmetrically arranged. The reinforcing portions 23 extend along directions from the diaphragm center hole 22 to the short edges 112 of the frame 1. Specifically in this embodiment, the reinforcing portions 23 are arched upwards, and the whole of them extends outwards from the middle portion of the diaphragm 2. There are four reinforcing portions 23, and for each reinforcing portion 23, its inner end is close to the diaphragm center hole 22, its outer end portion is close to the vertex portion of the diaphragm 2, and the whole of it extends straightly. In this embodiment, the reinforcing portions 23 and the main body of the diaphragm 2 are integrally provided, and are formed by arching upwards from the main body of the diaphragm 2. While in some other embodiments, the reinforcing portions 23 may be fixed on the upper surface or lower surface of the main body of the diaphragm 2, and the whole of it is strip-shaped. The first connecting portions 21 are located between adjacent reinforcing portions 23. The diaphragm 2 has a design structure rounded rectangular in shape, and enhances the reinforcing portions, compared with traditional oval-shaped diaphragms, the diaphragm of this embodiment has better rigidity, and is more stable during the vibration process of the loudspeaker, and has better stability for center of gravity, and easier shaping process in production.

### Embodiment 3

This embodiment differs from Embodiment 2 in the shape of the diaphragm 2. Referring to FIG. 8, the orthogonal projection of the diaphragm 2 on the horizontal plane is a racetrack shape, the middle portion is a rectangle, and the left and right sides are generally semi-circular in shape. The four reinforcing portions 23 extend from the diaphragm center hole 22 to the left and right sides of the diaphragm 2.

### Comparative Example

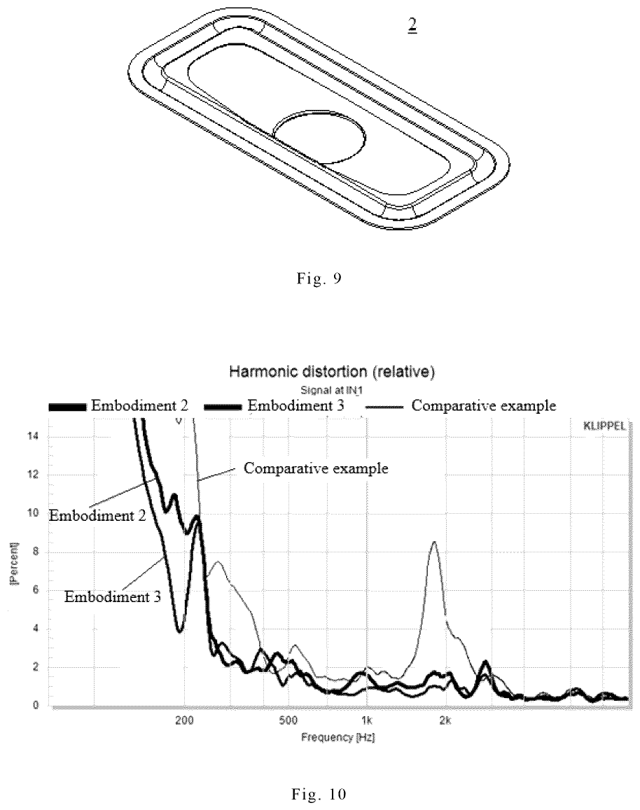

The vehicle loudspeaker of this comparative example differs from Embodiment 2 in the diaphragm 2. Referring to FIG. 9, the diaphragm 2 is provided with no first connecting portion recessed downwards, and provided with no reinforcing portion arched upwards. The height of the vehicle loudspeaker of this comparative example is generally consistent with that of the vehicle loudspeaker of Embodiment 2, with its mounting height of the dampers slightly higher.

The same performance test was carried on the vehicle loudspeakers of Embodiments 2 and 3 and the comparative example, and the distortion curves are shown in FIG. 10. In FIG. 10, the thickest curve represents the distortion curve of the vehicle loudspeaker of Embodiment 2, the second thickest curve represents the distortion curve of the vehicle loudspeaker of Embodiment 3, and the finest curve represents the distortion curve of the vehicle loudspeaker using the diaphragm 2 of the comparative example. It can be seen that, both the total harmonic distortions of the loudspeakers of Embodiment 2 and Embodiment 3 at the respective frequency bands are lower than that of the loudspeaker using the diaphragm 2 of the comparative example, their sound effect is closer to the original sound, and the distortion is smaller.

The diaphragms 2 of the above embodiments avoid the following problem: the diaphragm 2 is not completely rigid, and affected by its own processing technology and uneven material, the body of the diaphragm 2 will generate partition vibrations during vibration, causing peaks and/or valleys in the mid-frequency and high-frequency regions of the loudspeaker frequency, resulting in distortion. The diaphragms 2 of the above embodiments can effectively reduce the distortion.

The vehicle loudspeakers of the above embodiments reduce the overall height of the loudspeakers, increase the vibration amplitude of the loudspeakers, effectively reduce the resonant frequency of the loudspeakers so as to improve the low-frequency deepness, solve the problem of traditional loudspeaker structures of low bass extension caused by the reduction of spider area, and the problems of low power, transient distortion, and lateral movement distortion of the voice coil 3 when there is no spider, and realize the miniaturization and high-power function of the loudspeakers, at the same time, they can be mounted in narrow spaces, saving space inside automobiles; by using a non-circular diaphragm 2, compared to common circular drum-paper diaphragms 2, the radiating area of the loudspeakers is expanded, and the low-frequency volume of the loudspeakers is increased. The loudspeaker has better stability.

Those skilled in the art can understand that unless specifically stated, the singular forms “a”, “said”, and “the” used herein may also include the plural form. As shown in the description and claims of the present disclosure, the terms “comprising” and “containing” only indicate that the clearly identified steps and elements are included, and these steps and elements do not constitute an exclusive list, and the method or device may also include other steps or elements.

It should be further understood that in the present disclosure, “a plurality of” refers to two or more, and other quantifiers are similar.

It can be further understood that the terms “first”, “second”, etc. are used to describe various information, but this information should not be limited to these terms. These terms are only used to distinguish the same type of information from each other and do not indicate a specific order or degree of importance. In fact, expressions such as “first” and “second” can be used interchangeably. For example, without departing from the scope of the present disclosure, the first information can also be referred to as the second information, and similarly, the second information can also be referred to as the first information.

In this embodiment, unless otherwise expressly specified and limited, a first feature being “on” or “under” a second feature may include direct contact between the first feature and the second feature, as well as contact between the first feature and the second feature through an intermediate medium between them rather than direct contact. Also, the first feature being “on”, “above”, or “over” the second feature includes that the first feature is directly above or obliquely above the second feature, or simply means that the first feature is level higher than the second feature. The first feature being “under”, “below” or “underneath” the second feature includes that the first feature is directly below or obliquely below the second feature, or simply means that the first feature has a lower level than the second feature.

The embodiments described above are only for illustrating the technical concepts and features of the present disclosure, are preferred embodiments, and are intended to make those skilled in the art being able to understand the present disclosure and thereby implement it, and should not be concluded to limit the protective scope of this disclosure.

1. A vehicle loudspeaker comprising:
a frame;
a diaphragm having an outer edge connected to the frame;
a voice coil, an upper end portion of the voice coil being connected to a middle portion of the diaphragm; and
a magnetic drive unit having a magnetic gap, the magnetic drive unit being arranged on the frame,
wherein a lower end portion of the voice coil is inserted into the magnetic gap, and
wherein the vehicle loudspeaker further comprises two independent dampers spaced apart from each other, the two independent dampers are respectively located on two opposite sides of the voice coil, a part of an edge of each damper of the two independent dampers is connected to the frame, the diaphragm comprises two first connecting portions recessed downwards, and the two first connecting portions are connected to the two independent dampers respectively.

2. The vehicle loudspeaker of claim 1, wherein the frame comprises a housing and a magnetic drive unit mounting base, the housing is hollow and comprises an upper end that is open, the outer edge of the diaphragm is connected to an upper surface of the housing, the housing comprises a pair of long edges opposite to each other, the magnetic drive unit mounting base is located in the housing and fixedly connected to middle portions of the long edges, the magnetic drive unit is arranged on the magnetic drive unit mounting base, the two independent dampers are respectively arranged on two opposite sides of the magnetic drive unit mounting base, and the two independent dampers are located between the magnetic drive unit and the housing.

3. The vehicle loudspeaker of claim 2, wherein the frame further comprises two damper mounting pieces, the two independent dampers are arranged on the two damper mounting pieces respectively; the housing further comprises two short edges connected between end portions of the pair of long edges, and the two damper mounting pieces are fixedly connected to the end portions of the pair of long edges and/or the two short edges.

4. The vehicle loudspeaker of claim 3, wherein each damper of the two independent dampers comprises an outer edge connected to one of the two damper mounting pieces and a second connecting portion connected to one of the two first connecting portions of the diaphragm, and the outer edge of the damper is lower than the second connecting portion.

5. The vehicle loudspeaker of claim 4, wherein each damper of the two independent dampers further comprises a corrugated portion between the outer edge of the damper and the second connecting portion, and the outer edge of the damper is lower than the corrugated portion.

6. The vehicle loudspeaker of claim 4, wherein the outer edge of the damper is in a shape of an arc or a part of a rounded rectangle.

7. The vehicle loudspeaker of claim 2, wherein an orthogonal projection of the housing on a horizontal plane is a rectangle or a rounded rectangle, and the voice coil, the magnetic drive unit, and the two independent dampers are all accommodated in the housing.

8. The vehicle loudspeaker of claim 2, wherein the magnetic drive unit is single,
wherein the magnetic drive unit comprises a T-yoke, a magnetic steel sleeved on the T-yoke, and a front panel sleeved on the T-yoke, and
wherein the front panel is fixedly connected to the frame.

9. The vehicle loudspeaker of claim 1, wherein the diaphragm comprises a diaphragm center hole, the voice coil passes through the diaphragm center hole, and a dust cover is arranged on an upper end of the voice coil.

10. The vehicle loudspeaker of claim 9, wherein an orthogonal projection of the diaphragm on a horizontal plane is an oval or racetrack shape with a hole in a middle portion, and the diaphragm gradually tilts downwards from its edge to the diaphragm center hole.

11. The vehicle loudspeaker of claim 9, wherein the diaphragm comprises a plurality of reinforcing portions arched upwards or recessed downwards, and the plurality of reinforcing portions are respectively located at two opposite sides of the diaphragm center hole and symmetrically arranged.

12. The vehicle loudspeaker of claim 11, wherein the reinforcing portions extend from the diaphragm center hole to short edges of the frame.

13. A vehicle sound system comprising a headrest loudspeaker, wherein the headrest loudspeaker comprises the vehicle loudspeaker of claim 1.

14. A vehicle sound system comprising a roof loudspeaker, wherein the roof loudspeaker comprises the vehicle loudspeaker of claim 1.
